(19) United States
(12) Patent Application Publication
(10) Pub. No.: US 2007/0292183 A1
(43) Pub. Date: Dec. 20, 2007

(54) SHEET PROCESSING APPARATUS AND IMAGE FORMING APPARATUS

(75) Inventors: Tsuyoshi Moriyama, Toride-shi (JP); Yasuo Fukatsu, Abiko-shi (JP); Yuzo Matsumoto, Abiko-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/760,171

(22) Filed: Jun. 8, 2007

(30) Foreign Application Priority Data
Jun. 15, 2006 (JP) 2006-166199
Dec. 19, 2006 (JP) 2006-341404
Apr. 19, 2007 (JP) 2007-110537

(51) Int. Cl. G03G 15/00

(52) U.S. Cl. 399/407

(57) ABSTRACT

A sheet processing apparatus is coupled to an image forming apparatus having a first print mode and a second print mode in which an interval between sheets is larger than that in the first print mode when images are formed on sheets. The sheet processing apparatus includes a stapling unit to perform a stapling process on a bundle of image-formed sheets, and a controller to control the stapling unit. The controller controls the stapling unit such that a moving speed, at which the stapling unit presses the sheet bundle during the stapling process, is set lower in the second print mode than in the first print mode.

### BACKGROUND OF THE INVENTION

1. Field of the Invention

The present invention relates to a sheet processing apparatus configured to perform a stapling process on a bundle of sheets subjected to image formation and also relates to an image forming apparatus including the sheet processing apparatus.

2. Description of the Related Art

Some conventional image forming apparatuses, such as copying machines, include a sheet processing apparatus configured to receive a given number of image-formed sheets and to bind together the sheets with a binding unit (stapler) having a staple driver portion (hereinafter referred to as a “driver portion”) (see Japanese Patent Application Laid-Open No. 05-008580).

In such a conventional sheet processing apparatus, if the number of received sheets is within a set range, the stapler is driven to bind the image-formed sheets together.

As illustrated in FIG. 21, the stapling operation is divided into a driver portion moving region, in which the driver portion moves towards a sheet bundle, and a staple driving region, in which the driver portion drives a staple through the sheets after pressing the sheet bundle. In the conventional sheet processing apparatus, as productivity takes precedence, the stapler is generally set to operate at a highest operating speed.

In the aforementioned conventional stapler, especially, a large stapler, an impact noise generated by the driver portion contacting the sheets during the stapling operation may be problematic. Depending on an environment or a time zone for using an image forming apparatus, a further reduction in operation noise of the entire apparatus may be demanded.

However, in the conventional image forming apparatus, a stapling operation speed of the stapler is constantly set high (e.g., the stapler operates at its highest operating speed) in any print mode because of the precedence on productivity. Thus, an operation noise level generated during a stapling operation of conventional image forming apparatus will generally remain constant regardless of a selected print mode.

### SUMMARY OF THE INVENTION

An embodiment of the present invention is directed to a sheet processing apparatus and an image forming apparatus capable of reducing an impact noise generated when a driver portion of a stapler contacts a sheet bundle, i.e., capable of reducing an operation noise during a stapling operation, without decreasing productivity.

According to an aspect of the present invention, an embodiment is directed to a sheet processing apparatus coupled to an image forming apparatus having a first print mode and a second print mode in which an interval between sheets is larger than that in the first print mode when images are formed on sheets. The sheet processing apparatus includes a stapling unit configured to perform a stapling process on a bundle of image-formed sheets, and a controller configured to control the stapling unit such that a moving speed at which the stapling unit presses the sheet bundle for the stapling process in the second print mode is lower than that in the first print mode.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating an image forming apparatus which includes a sheet processing apparatus according to a first exemplary embodiment of the present invention.

FIG. 2 is a control block diagram of the image forming apparatus.

FIG. 3 is a diagram illustrating a configuration of a finisher serving as the sheet processing apparatus.

FIG. 4 is a control block diagram of the sheet processing apparatus.

FIG. 5 is a diagram illustrating an operation portion disposed on the image forming apparatus.

FIG. 6 is a diagram illustrating a flow of sheets from an inserter and the image forming apparatus into the sheet processing apparatus.

FIG. 7 is a diagram illustrating a flow of sheets from the inserter and the image forming apparatus into the sheet processing apparatus.

FIG. 8 is a diagram illustrating a flow of sheet from the inserter and the image forming apparatus into the sheet processing apparatus.

FIG. 9 is a diagram illustrating a flow of sheets from the inserter and the image forming apparatus into the sheet processing apparatus.

FIG. 10 is a flowchart illustrating a procedure for setting a moving speed of a driver portion of a stapler according to a second exemplary embodiment of the present invention.

FIG. 11 is a flowchart illustrating a procedure for changing a moving speed of a driver portion based on the number of sheets according to a third exemplary embodiment of the present invention.

FIG. 12 is a flowchart illustrating a procedure for changing the moving speed of the driver portion based on the thickness of a sheet bundle according to the third exemplary embodiment of the present invention.

FIG. 13 is a diagram illustrating a driver portion of a stapler.

FIG. 14 is a diagram illustrating a moving speed table for the driver portion in a silent mode.

FIG. 15 is a diagram illustrating a sheet thickness detection portion.

FIG. 16 is a diagram illustrating output characteristics of a sheet thickness sensor.

FIG. 17 is a diagram illustrating sheet feeding timing of a sheet feeding controller.

FIG. 18 is a flowchart illustrating a procedure for setting a time interval between sheets in the sheet feeding controller.

FIG. 19 is a flowchart illustrating a procedure for changing the moving speed of the driver portion based on a print mode.

FIG. 20 is a flowchart illustrating a procedure for changing the moving speed of the driver portion based on a sheet size.

FIG. 21 is a diagram illustrating a moving speed table for the driver portion in a normal mode.

### DETAILED DESCRIPTION OF THE EMBODIMENTS

Various exemplary embodiments, features, and aspects of the invention will be described in detail below with reference to the drawings.

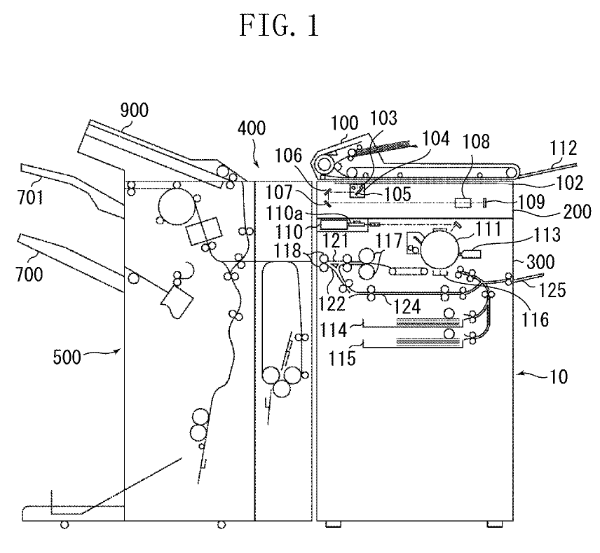

FIG. 1 illustrates a configuration of an image forming apparatus which includes a sheet processing apparatus according to a first exemplary embodiment of the present invention. As illustrated in FIG. 1, the image forming apparatus includes an image forming apparatus body 10, a folding device 400, and a finisher 500. The image forming apparatus body 10 includes an image reader 200 for reading a document image, and a printer 300.

A document feeding device 100 is mounted on the image reader 200. The document feeding device 100 feeds documents set face-up on a document tray sequentially one by one from a head page to the left, conveys the documents through a reading position from left to right on a platen glass 102 via a curved path, and then discharges the documents to an external discharge tray 112. When the documents pass through the reading position from left to right on the platen glass 102, images on the documents are read by a scanner unit 104 held in a position corresponding to the reading position. This reading method is generally referred to as a document flow reading method. Specifically, when the documents pass through the reading position, reading surfaces of the documents are illuminated with light from a lamp 103 of the scanner unit 104. Reflected light from the documents is guided through mirrors 105 to 107 to a lens 108. The light having passed through the lens 108 forms an image on an imaging plane of an image sensor 109.

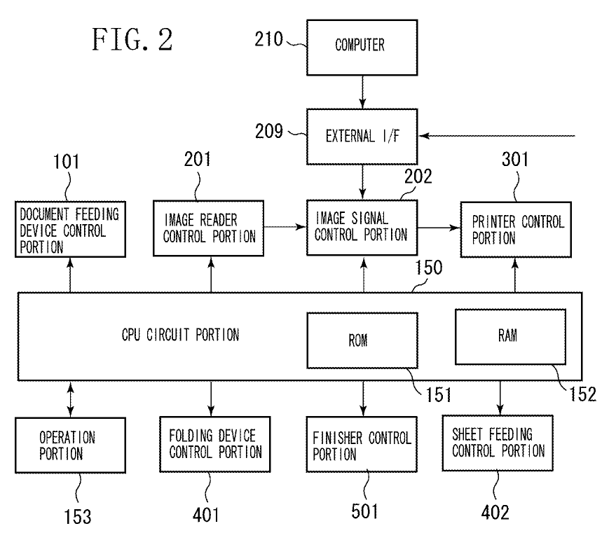

The conveyance of a document through the reading position from left to right enables execution of document reading and scanning, in which a direction orthogonal to a document conveying direction is referred to as a main scanning direction and the document conveying direction is referred to as a subscanning direction. When the document passes through the reading position, the document is conveyed in the subscanning direction while a document image is read for each line in the main scanning direction by the image sensor 109, so that the entire document image is read. The optically read image is converted into image data to be output by the image sensor 109. The image data output from the image sensor 109 is subjected to predetermined processing in an image signal control portion 202 (FIG. 2), and then supplied as a video signal to an exposure control portion 110 of the printer 300.

In addition, the document can be conveyed on the platen glass 102 by the document feeding device 100 and be stopped in a predetermined position. Then, the document image can be read by the scanning unit 104 moving from left to right in that state. This reading method is referred to as a document fixed reading method.

When the document is read without using the document feeding device 100, a user lifts the document feeding device 100 to set the document on the platen glass 102. Subsequently, the document is scanned from left to right by the scanner unit 104 to be read. In other words, the document fixed reading method is carried out when the document is read without using the document feeding device 100.

The exposure control portion 110 of the printer 300 modulates and outputs a laser beam based on the input video signal. The laser beam is used for scanning by a polygon mirror 110a to be applied to a photosensitive drum 111. An electrostatic latent image is formed on the photosensitive drum 111 according to the laser beam used for scanning. As described below, the exposure control portion 110 outputs a laser beam such that a correct image (an image which is not a mirror image) can be formed during the document fixed reading.

The electrostatic latent image on the photosensitive drum 111 is visualized as a developer image by a developer supplied from a developing device 113, which constitutes an image forming portion together with the photosensitive drum 111. At timing synchronized with an illumination start of the laser beam, a sheet is fed from a cassette 114 or 115, a manual sheet feeding portion 125, or a two-sided conveyance path 124, which serves as a sheet feeding portion. The sheet is conveyed to a space between the photosensitive drum 111 and a transfer portion 116. The developer image formed on the photosensitive drum 111 is transferred to the sheet fed by the transfer portion 116.

The sheet to which the developer image has been transferred is conveyed to a fixing portion 117. The fixing portion 117 heat-presses the sheet to fix the developer image thereon. The sheet having passed through the fixing portion 117 is conveyed through a flapper 121 and a discharge roller 118 to be discharged from the printer 300 to the outside (the folding device 400).

When the sheet is discharged in a face-down state of the image forming surface, the sheet having passed through the fixing portion 117 is first guided through a sheet surface reverse path 122 by a switching operation of the flapper 121. After the trailing end of the sheet passes through the flapper 121, the sheet is switched back to be discharged from the printer 300 by the discharge roller 118. This discharge method is referred to as a reverse discharge method. The reverse discharge method is carried out when images are sequentially formed from a head page, such as when images read by using the document feeding device 100 are formed or when images output from a computer 210 (FIG. 2) are formed. Then, a sequence of the discharged sheets matches a correct sequence of pages.

When a hard sheet, such an overhead projector (OHP) sheet, is fed from the manual sheet feeding portion 125 to form an image on the hard sheet, the sheet is not guided through the sheet surface reverse path 122 but discharged by the discharge roller 118 in a face-up state of the image forming surface.

When two-sided recording for forming images on two sides of a sheet is set, the sheet is guided through the sheet surface reverse path 122 by a switching operation of the flapper 121 to be conveyed through the two-sided conveyance path 124. Then, the sheet guided through the two-side conveyance path 124 is fed again to a space between the photosensitive drum 111 and the transfer portion 116 at the aforementioned timing.

The sheet discharged from the printer 300 is sent to the folding device 400. The folding device 400 folds the sheet into a Z shape. For example, in the case of an A3 or A4 size sheet designated to be folded, the folding device 400 folds the sheet. In other cases, the sheet discharged from the printer 300 is sent through the folding device 400 to the finisher 500. The finisher 500 includes an inserter 900 for feeding a special sheet, such as a cover sheet or a slip sheet, to be inserted into image-formed sheets. The finisher 500 performs processing on the sheets, such as bookbinding, binding, or punching.

Next, referring to FIG. 2, a configuration of a controller serving as a control unit to control the entire image forming apparatus will be described. FIG. 2 is a block diagram illustrating the configuration of the controller to control the image forming apparatus illustrated in FIG. 1.

As illustrated in FIG. 2, the controller includes a central processing unit (CPU) circuit portion 150. The CPU circuit portion 150 contains a read-only memory (ROM) 151 and a random access memory (RAM) 152, and controls blocks 101, 153, 201, 209, 301, 401, and 501 based on a control program stored in the ROM 151. The RAM 152 is used as a work area for temporarily holding control data and executing an arithmetic processing operation.

A document feeding device control portion 101 drives and controls the document feeding device 100 based on an instruction from the CPU circuit portion 150. An image reader control portion 201 drives and controls the scanner unit 104 and the image sensor 109, and transfers an analog image signal output from the image sensor 109 to an image signal control portion 202.

The image signal control portion 202 executes various processing after conversion of the analog image signal from the image sensor 109 into a digital signal, and converts the digital signal into a video signal to be output to a printer control portion 301. Alternatively, the image signal control portion 202 executes various processing on a digital image signal input from the computer 210 via an external interface (I/F) 209, and converts the digital image signal into a video signal to be output to the printer control portion 301. A processing operation of the image signal control portion 202 is controlled by the CPU circuit portion 150. The printer control portion 301 drives the exposure control portion 110 based on the input video signal.

An operation portion 153 disposed on the image forming apparatus body 10 includes a plurality of keys for setting various functions regarding image formation, and a display portion for displaying information indicating a set state, and outputs a key signal corresponding to each key operation to the CPU circuit portion 150. Then, corresponding information is displayed in the display portion based on a signal from the CPU circuit portion 150.

A folding device control portion 401 is mounted on the folding device 400, and drives and controls the entire folding device 400 by transferring information with the CPU circuit portion 150 through communication.

A finisher control portion 501 is mounted on the finisher 500, and drives and controls the entire finisher 500 by transferring information with the CPU circuit portion 150. Control contents of the finisher control portion 501 will be described below.

A configuration in which the folding device control portion 401 and the finisher control portion 501 are respectively mounted on the folding device 400 and the finisher 500 according to the present embodiment will be described. The folding device control portion 401 and the finisher control portion 501 can be disposed on the image forming apparatus body 10 integrally with the CPU circuit portion 150 to be directly controlled by the image forming apparatus body 10.

A sheet feeding control portion 402 controls sheet feeding timing for feeding sheets to the image forming portion. Based on time necessary for actual sheet processing sent from the finisher control portion 501, the sheets are fed to the image forming portion at appropriate intervals. For example, a sheet feeding interval changes when sheet feeding in the image forming apparatus body 10 needs to wait because of stapling processing time in the finisher 500.

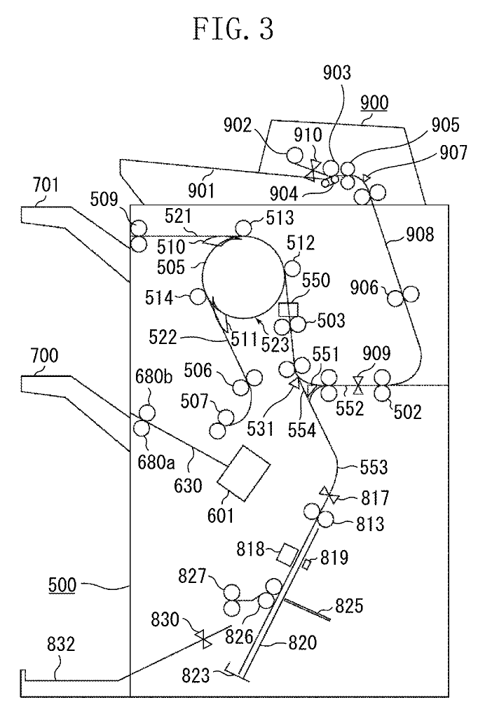

Next, referring to FIG. 3, a configuration of the finisher 500 will be described. The finisher 500 sequentially receives sheets discharged via the folding device 400. The finisher 500 performs various post-processing on sheets, such as processing for aligning and bundling a plurality of received sheets into a bundle, stapling processing for binging a tail end of the sheet bundle with staples, processing for punching the vicinity of the tail ends of the received sheets, sorting, nonsorting, and bookbinding.

As illustrated in FIG. 3, the finisher 500 includes an entrance roller pair 502 for guiding a sheet discharged from the printer 300 via the folding device 400 into the finisher 500. A switching flapper 551 for guiding the sheet through a finisher path 552 or a first bookbinding path 553 is disposed on a downstream side of the entrance roller pair 502.

The sheet guided through the finisher path 552 is sent to a buffer roller 505 via a conveyance roller pair 503. The conveyance roller pair 503 and the buffer roller pair 505 are configured to be reversibly rotated.

An entrance sensor 531 is disposed between the entrance roller pair 502 and the conveyance roller pair 503. A second bookbinding path 554 branches from the finisher path 552 in the vicinity of the sheet conveying direction upstream side of the entrance sensor 531. This branch point forms a branch into a conveyance path for conveying sheets from the entrance roller pair 502 to the conveyance roller pair 503. When the conveyance roller pair 503 rotates reversely to convey a sheet from the conveyance roller pair 503 to the entrance sensor 531, a branch which has a one-way mechanism for conveying the sheet only to the second bookbinding path 554 is formed.

A punch unit 550 is disposed between the conveyance roller pair 503 and the buffer roller 505. The punch unit 505 operates to bore holes in the vicinity of tail ends of the conveyed sheets when a need arises.

The buffer roller 505 enables stacking and winding of a predetermined number of sheets sent to its outer periphery. The sheets are wound on the outer periphery of the buffer roller 305 by press rollers 512 to 514 as occasion demands. The sheets wound on the buffer roller 505 are conveyed in a rotational direction of the buffer roller 505.

The winding of sheets on the buffer roller 505 is carried out when subsequent sheets are temporarily buffered during stapling processing on a processing tray 630. The predetermined number of wound sheets are conveyed to the processing tray 630 in a stacked state of the predetermined number of sheets at appropriate time when no collision occurs with the previous bundle.

A switching flapper 510 is arranged between the press rollers 513 and 514, and a switching flapper 511 is arranged on a downstream side of the press roller 514. The switching flapper 510 peels off the sheets wound on the buffer roller 505 therefrom to guide the sheets through a nonsort path 521 or a sort path 522. The switching flapper 511 peels off the sheets wound on the buffer roller 505 therefrom to guide the sheets through the sort path 522, or through a buffer path 523 in the wound state of the sheets on the buffer roller 505.

The sheets guided through the nonsort path 521 by the switching flapper 510 are discharged to a sample tray 701 via a discharge roller pair 509.

The sheets guided through the sort path 522 by the switching flapper 510 are stacked on an intermediate tray (a processing tray) 630 via conveyance rollers 506 and 507. The sheets stacked on the processing tray 630 are aligned and stapled by a stapler 601 as occasion demands and then discharged to a stack tray 700 via discharge rollers 680a and 680b. The stapler 601 is used to perform stapling processing for binding the sheets stacked on the processing tray 630. The stack tray 700 is movable upward and downward.

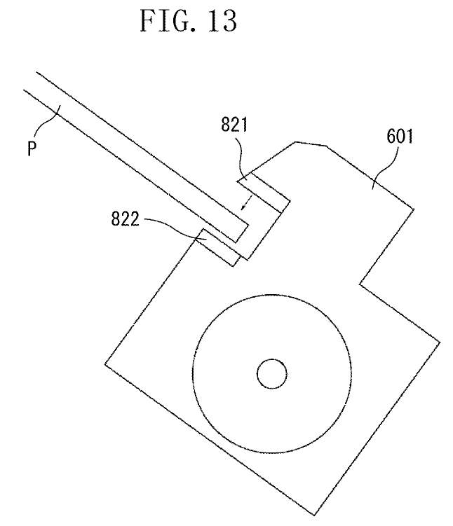

FIG. 13 illustrates a configuration of the stapler 601, which serves as a stapling unit. A driver portion 821, which serves as a contact portion, moves in the direction of an arrow during a stapling operation, and contacts a sheet bundle P to press its upper surface. Almost simultaneously, staples are driven through the sheet bundle P by a stapling portion 822. The driven staples are folded at the driver portion 821 to complete the stapling processing. The stapling portion 822 can be disposed integrally with the driver portion 821, and can move integrally.

Referring back to FIG. 2, the sheets from the first or second bookbinding path 553 or 554 are received in a reception guide 820 by a conveyance roller pair 813, and conveyed until the leading end of the sheet comes into contact with a movable sheet positioning member 823. A bookbinding entrance sensor 817 is arranged on an upstream side of the conveyance roller pair 813. A pair of staplers 818 are disposed in a middle position of the reception guide 820. The stapler 818 cooperates with an opposing anvil 819 to bind the middle portion of the sheet bundle.

A folding roller pair 826 is disposed in a downstream position of the stapler 818. A projecting member 825 is disposed in an opposing position of the folding roller pair 826. By projecting the projecting member 825 toward the sheet bundle received in the reception guide 820, the sheet bundle is pushed out between the pair of folding rollers 826. The sheet bundle is folded by the folding roller pair 826 to be discharged to a saddle discharge tray 832 via a folded sheet discharge roller 827. A bookbound sheet discharge sensor 830 is arranged on a downstream side of the folded sheet discharge roller 827.

When the sheet bundle bound by the stapler 818 is to be folded, the positioning member 823 is lowered by a predetermined distance after the end of stapling processing so that a stapled position of the sheet bundle can match a center position of the folding roller pair 826.

The inserter 900 is disposed above the finisher 500. The inserter 900 sequentially separates a bundle of sheets including cover or slip sheets stacked on a tray 901 to convey the sheets through the finisher path 552 or the bookbinding path 553. In this case, special sheets are stacked on the tray 901 of the inserter 900 in a state of being looked at straight from a user. In other words, the special sheets are stacked face-up on the tray 901.

The special sheets on the tray 901 are conveyed to a separation portion including a conveyance roller 903 and a separation belt 904 by a sheet feeding roller 902, and sequentially separated one by one from a top sheet to be conveyed.

An extraction roller pair 905 is arranged on a downstream side of the separation portion. The special sheets separated by the extraction roller pair 905 are stably guided through a conveyance path 908. A sheet feeding sensor 907 is arranged on a downstream side of the extraction roller pair 905. A conveyance roller 906 is disposed between the sheet feeding sensor 907 and the entrance roller pair 502 to guide the special sheets through the conveyance path 908 to the entrance roller pair 502.

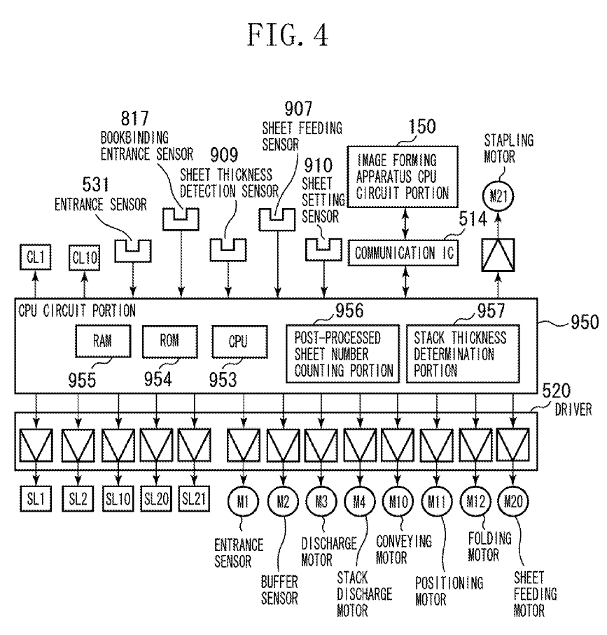

Next, referring to FIG. 4, a configuration of the finisher control portion 501 for driving and controlling the finisher 500 will be described. FIG. 4 is a block diagram illustrating the configuration of the finisher control portion 501 in FIG. 2. There can be additional components, such as motors and sensors, not shown in FIG. 4. However, the components unrelated to the present invention are omitted.

As illustrated in FIG. 4, the finisher control portion 501 includes a CPU circuit portion 950 which contains a CPU 853, a ROM 954, and a RAM 955. The CPU circuit portion 950 communicates with the CPU circuit portion 150 disposed in the image forming apparatus body 10 via a communication integrated circuit (IC) 514 to exchange data. Then, the CPU circuit portion 950 executes various programs stored in the ROM 954 to drive and control the finisher 500 based on an instruction from the CPU circuit portion 150.

A post-processed sheet number counting portion 956 counts the number of sheets of a sheet bundle to be stapled on the processing tray 630. Specifically, the post-processed sheet number counting portion 956 can count the number of sheets by counting input signals from the entrance sensor 531, i.e., the number of sheets passing through the entrance sensor 531.

A bundle thickness determination portion 957 calculates the thickness of a sheet bundle to be post-processed on the processing tray 630 based on an input signal from a sheet thickness detection sensor 909. The post-processed sheet number counting portion 956 and the bundle thickness determination portion 957 can be disposed on the image forming apparatus body 10.

When driving and controlling the finisher 500 are carried out, detection signals from various sensors are supplied to the CPU circuit portion 950. The sensors include an entrance sensor 531, a bookbinding entrance sensor 817, a sheet feeding sensor 907, and a sheet setting sensor 910. The sheet setting sensor 910 detects whether special sheets have been set on the tray 901 of the inserter 900. A driver 520 is connected to the CPU circuit portion 950. The driver 520 drives motors and solenoids based on signals from the CPU circuit portion 950. The CPU circuit portion 950 drives clutches.

The motors include an entrance motor M1 which is a driving source for the entrance roller pair 502, the conveyance roller pair 503, and the conveyance roller pair 906, a buffer motor M2 which is a driving source for the buffer roller 505, a discharge motor M3 which is a driving source for the conveyance roller pair 506, the discharge roller pair 507, and the discharge roller pair 509, a bundle discharge motor M4 for driving the discharge rollers 680a and 680b, a conveyance motor M10 which is a driving source for the conveyance roller pair 813, a positioning motor M11 which is a driving source for the sheet positioning member 823, a folding motor M12 which is a driving source for the projecting member 825, the folding roller pair 826, and the folded sheet discharge roller pair 827, a sheet feeding motor M20 which is a driving source for the sheet feeding roller 902, the conveyance roller 903, the separation belt 904, and the extraction roller pair 905 of the inserter 900, and a stapling motor M21 for stapling a sheet bundle on the processing tray 630.

The entrance motor M1, the buffer motor M2, and the discharge motor M3 are stepping motors. By controlling an exciting pulse rate, a pair of rollers driven by each motor can be rotated at equal speeds or independent speeds. The entrance motor M1 and the buffer motor M2 can be driven in both forward and backward rotational directions by the driver 520.

The conveyance motor M10 and the positioning motor M11 are stepping motors, and the folding motor M12 is a DC motor. The conveyance motor M10 enables sheet conveying at a speed synchronized with that of the entrance motor M1.

The sheet feeding motor M20 is a stepping motor, and enables sheet conveying at a speed synchronized with that of the entrance motor M1.

The stapler motor M21 is a stepping motor, and controlled to achieve a predetermined stapling operation speed. According to an embodiment, the stapling motor M21 is a stepping motor. However, by using other components such as a DC motor and a FG sensor, servo control can be executed.

The solenoids include a solenoid SL1 for switching of the switching flapper 510, a solenoid SL2 for switching of the switching flapper 511, a solenoid SL10 for switching of the switching flapper 551, a solenoid SL20 for driving a sheet feeding shutter (not shown in FIG. 3) of the inserter 900, and a solenoid SL21 for elevating and driving the sheet feeding roller 902 of the inserter 900.

The clutches include a clutch CL1 for transmitting driving of the folding motor M12 to the projecting member 825, and a clutch CL10 for transmitting driving of the sheet feeding motor M20 to the sheet feeding roller 902.

The sheet thickness detection sensor 909 for detecting the thickness of a sheet is disposed in the finisher path 552, which is a confluence path between a path for conveying sheets from the folding device 400 and a path for conveying inserted sheets.

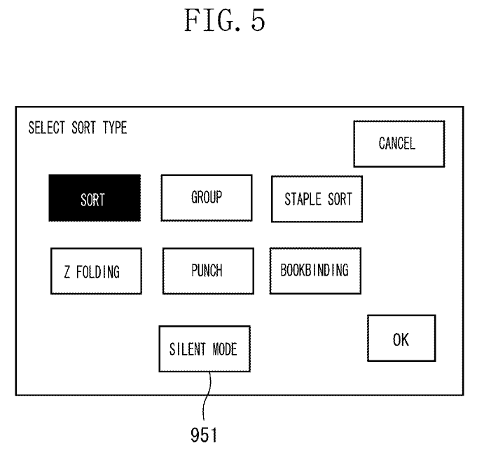

Next, referring to FIG. 5, a selection operation example of a post-processing mode of the operation portion 153 will be described. FIG. 5 illustrates a screen example regarding a post-processing mode selection on the operation portion 153 in the image forming apparatus illustrated in FIG. 1.

The image forming apparatus has various post-processing modes, such as a nonsort mode, a sort mode, a staple sort mode (binding mode), and a bookbinding mode. A sheet insertion mode can be set to enable insertion of a sheet as a cover sheet, a last sheet or a middle sheet. Such processing mode setting is carried out by an input operation on the operation portion 153. For example, when a post-processing mode is set, a menu selection screen illustrated in FIG. 5 is displayed on the operation portion 153, and a processing mode can be set via the menu selection screen. In the image forming apparatus, the staple sort mode (binding mode) includes a normal mode and a silent mode. A silent mode key 951 is provided as a switching portion in the operation portion 153. When the staple sort mode is selected while the silent mode key 951 is selected, a mode for silencing stapling processing is set as described below.

According to an embodiment, the silent mode is set via the operation portion 153 of the image forming apparatus. However, the silent mode can be set via a printer setting screen of the external computer 210 as an input portion. Additionally, a switch can be directly disposed as a switching portion in the finisher 500 to be used during a manual stapling operation.

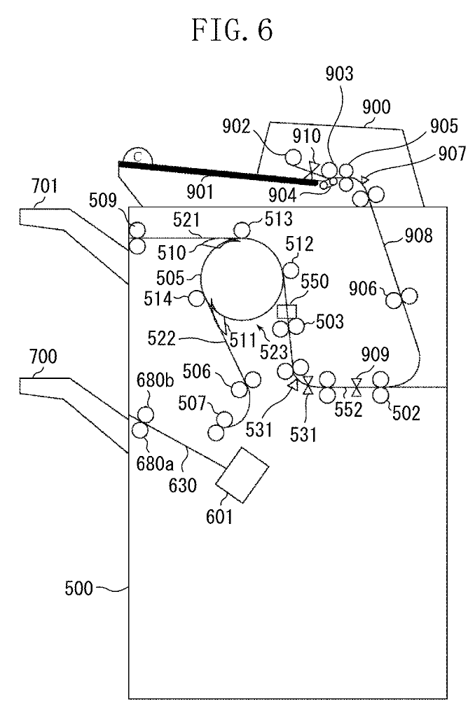

Next, referring to FIGS. 6 to 9, sheet conveyance from the inserter 900 and the printer 300 to the processing tray 630 in the finisher 500 in the sort mode will be described. FIGS. 6 to 9 illustrate flows of sheets from the inserter 900 and the printer 300 to the processing tray 630 in the finisher 500 in the sort mode of the image forming apparatus illustrated in FIG. 1. For convenience of description, a bookbinding portion is omitted.

As illustrated in FIG. 6, when a sheet C is inserted as a cover sheet into image-formed sheets, the sheet C is set on the tray 901 of the inserter 900.

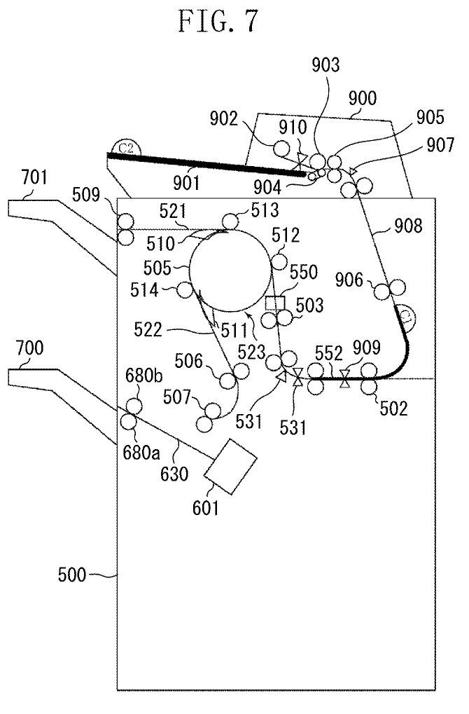

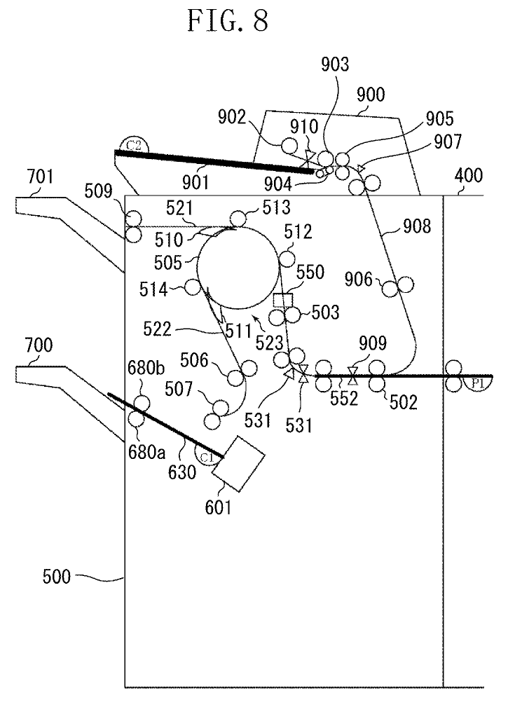

As illustrated in FIG. 7, upon setting of the sheet C on the tray 901, feeding of a top sheet C1 is started, and the switching flapper 551 is set to the finisher path 552 side. The sheet C1 is guided from the conveyance path 908 through the entrance roller pair 502 into the finisher path 552. When a leading end of the sheet C1 is detected by the entrance sensor 531, feeding of an image-formed sheet (sheet P1 shown in FIG. 8) from the printer 300 is started.

Then, the sheet P1 fed from the printer 300 is guided into the finisher 500, and the sheet C1 is guided through the sort path 522 via the buffer roller 505. At this time, both the switching flappers 510 and 511 are switched to the sort path 522 side.

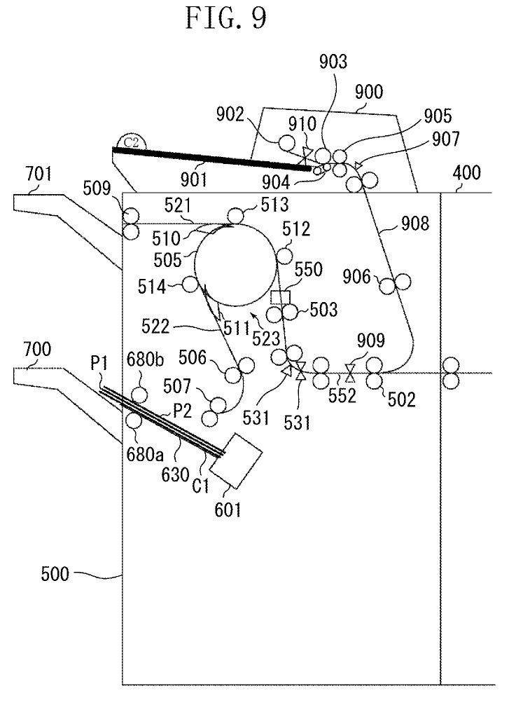

As illustrated in FIG. 8, the sheet C1 guided through the sort path 522 is received in the processing tray 630. At this time, the sheet P1 from the printer 300 has been guided through the finisher path 522. As in the case of the sheet C1, the sheet P1 is guided through the sort path 522 via the buffer roller 505 to be conveyed to the processing tray 630. A sheet P2, which follows the sheet P1, is also guided through the finisher path 552. Then, as illustrated in FIG. 9, the sheet P1 is stacked on the sheet C1 received on the processing tray 630, and the subsequent sheet P2 is stacked on the sheet P1.

The sheets P1 and P2 fed from the printer 300 have images subjected to mirror image processing. The sheets P1 and P2 are reversed to be discharged. Accordingly, as in the case of the sheet C1, the sheets P1 and P2 are received on the processing tray 630 with image surfaces thereof set face-down and binding positions thereof directed to the stapler 601 side. Although not illustrated in FIG. 9, when there is a special sheet to be inserted into the next sheet bundle, the special sheet is fed through the conveyance path 908 and waits during feeding of the sheets P1 and P2 constituting the preceding sheet bundle. This configuration enables improvement of productivity during sort mode processing.

### First Exemplary Embodiment

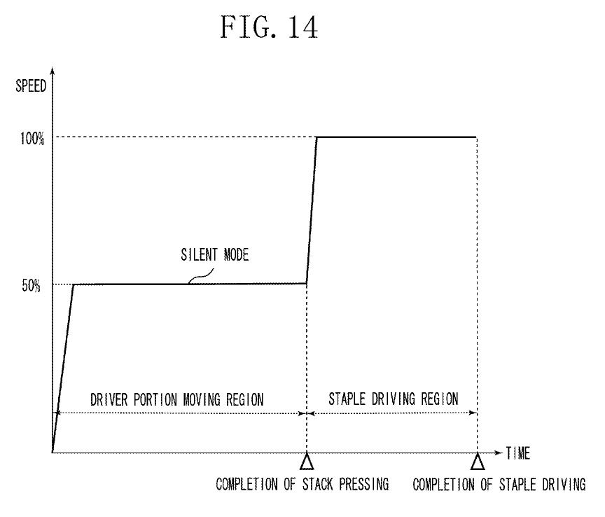

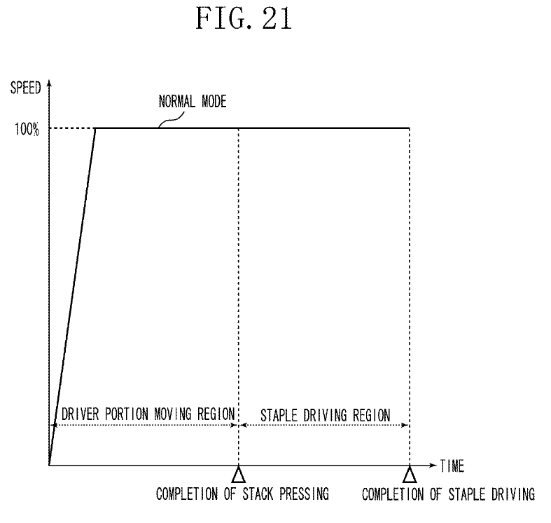

In accordance with an embodiment, the image forming apparatus is operable in a normal mode and a silent mode relating to a stapling operation of the stapler 601. Referring to FIGS. 21 and 14, a moving speed table for the driver portion 821, which serves as a contact portion of the stapler 601, in the normal and silent modes will be described.

FIG. 21 illustrates a moving speed table for the driver portion 821 of the stapler 601 in the normal mode. As illustrated in FIG. 21, the stapling operation is divided into a moving region of the driver portion 821 and a staple driving region thereafter. In the normal mode, as productivity takes precedence, the moving speed of the driver portion 821 is set high (e.g., the stapler 601 is set to operate at a highest operating speed).

FIG. 14 illustrates a moving speed table for the driver portion 821 of the stapler 601 in the silent mode. In one implementation, in the silent mode, the moving speed of the driver portion 821 is set to 50% of the normal (highest) moving speed. By setting the moving speed of the driver portion 821 low in the silent mode, an impact sound generated between the driver portion 821 and the sheet bundle P can be reduced. A staple driving operation is started after completion of a bundle pressing operation. At this time, a staple driving speed is set to 100%. This is for the purpose of preventing staple driving mistakes by securing a penetrating force of staples to penetrate the sheet bundle P. The penetrating force is larger as an initial speed at the time of starting driving is higher. In the present embodiment, a mechanism of generation of an impact sound, when the driver portion 821 contacts a stationary sheet bundle P, is described, but the impact sound is influenced by the relative velocity between a contact portion and a sheet bundle. As a result, in a configuration in which the sheet bundle also moves, reducing the relative velocity between the contact portion and the sheet bundle can also silence the impact sound.

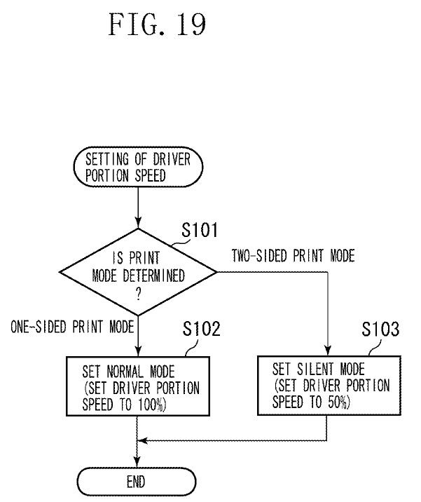

Next, referring to FIG. 19, a flow of automatically selecting the normal or silent mode of the stapling operation according to a print mode to set a moving speed of the driver portion 821, which serves as a contact portion, will be described.

Generally, printing productivity in a two-sided print mode, which is a second print mode, drops by about 50% as compared with productivity in a one-sided print mode, which is a first print mode. In other words, as a time interval between sheets is longer in the two-sided print mode as compared with that in the one-sided print mode, a time for stapling processing can be set longer. Accordingly, if the moving speed of the driver portion 821 of the stapler 601 is set low in the two-sided print mode, an operation noise associated with a stapling operation of the stapler 601 can be silenced or at least reduced without adversely effecting productivity.

First, in step S101, the finisher control portion 501 determines a print mode. If the print mode is a one-sided print mode, the finisher control portion 501 proceeds to step S102 to select a normal mode for operating the stapler. In the normal mode, the finisher control portion 501 sets the moving speed of the driver portion 821 to 100%. This speed is the highest moving speed of the driver portion 821. If the print mode is determined to be a two-sided print mode in step S101, the finisher control portion 501 proceeds to step S103 to select a silent mode (e.g., reduced noise mode) for operating the stapler. In the silent mode, the moving speed of the driver portion 821 is set to 50% of the highest moving speed. By setting low the moving speed of the driver portion 821 in the silent mode in the case of the two-sided print mode, an impact noise generated when the driver portion 821 contacts a sheet bundle can be reduced.

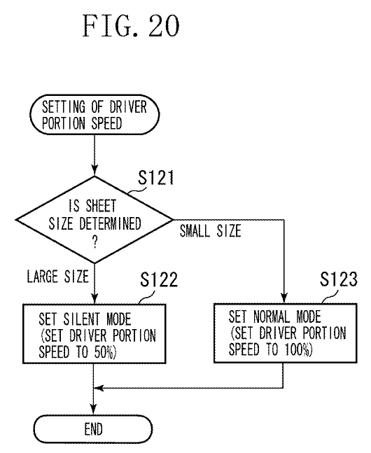

Next, referring to FIG. 20, a flow of switching a stapling operation mode between the normal mode and the silent mode according to a sheet size to be printed will be described.

Generally, printing productivity drops by about 50% in the case of large-size (e.g., A3 size) printing (second print mode) as compared with the case of small-size (e.g., A4 size) printing (first print mode). In other words, when printing is carried out with a small-size sheet, a time interval between sheets is longer as compared with printing with a small-size sheet. Thus, a time for stapling processing can be made longer. As a result, if the moving speed of the driver portion 821 of the stapler 601 is set low in printing with a large-size sheet as in the case of the aforementioned flow, an operation noise associated with a stapling operation of the stapler 601 can be silenced or at least reduced without adversely effecting productivity.

First, in step S121, the finisher control portion 501 determines a sheet size to be printed. If the sheet size is small (e.g., A4 size), the finisher control portion 501 proceeds to step S123 to select a normal mode for operating the stapler. In the normal mode, the finisher control portion 501 sets the moving speed of the driver portion 821 to 100%. If the sheet size is determined to be large (e.g., A3 size) in step S121, the finisher control portion 501 proceeds to step S122 to select a silent mode (e.g., reduced noise mode) for operating the stapler. In the silent mode, the finisher control portion 501 sets the driving speed of the driver portion 821 to 50% of the highest moving speed. By setting low the moving speed of the driver portion 821 in the silent mode in the case of the large-size print mode, an impact noise generated when the driver portion 821 contacts a sheet bundle can be reduced.

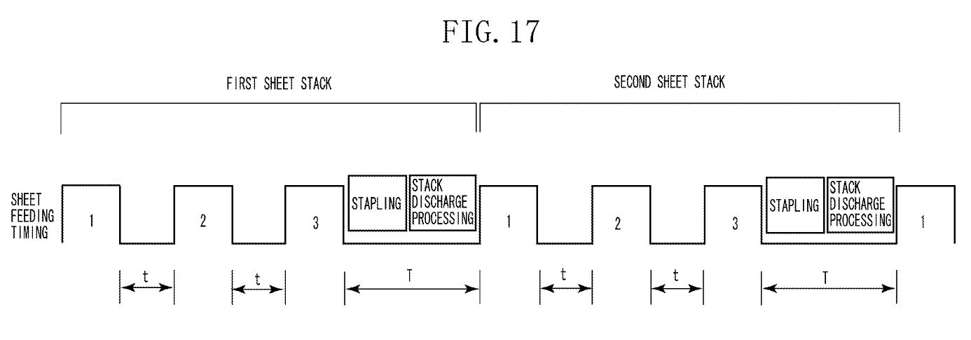

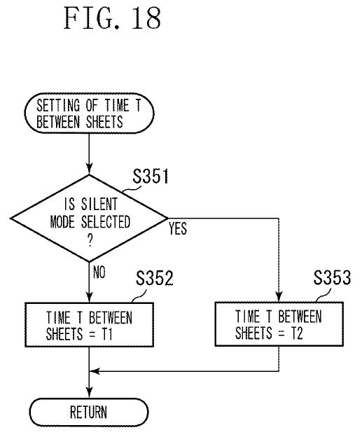

Next, referring to FIGS. 17 and 18, a time interval between sheets required when the sheet feeding control portion 402 controls sheet feeding timing (sheet feeding interval) for feeding sheets to the image forming portion will be described. FIG. 17 is a diagram illustrating sheet feeding timing. As an example, a case in which the number of sheets to constitute a sheet bundle is three will be described. An interval between sheets is a time from passage of the tail end of a sheet to arrival of the leading end of the next sheet. Processing, such as aligning or binding, is carried out within this time. Numerals in FIG. 17 indicate a feeding sequence of sheets of a sheet bundle, t is an interval between sheets of the sheet bundle, and T is an interval between the last sheet of a preceding sheet tack and the first sheet of a subsequent sheet bundle. Values of t and T are appropriately set according to a print mode, such as a two-sized print mode or a large-size print mode. Stapling processing and subsequent sheet bundle discharging processing to the stack tray 700 are carried out in the interval T between sheets. In the silent mode, as the moving speed of the driver portion 821 is set low, a time required for the entire stapling operation is longer as compared with the normal mode. Accordingly, a sheet feeding interval for feeding sheets to the image forming portion is set longer by a predetermined time during the stapling mode execution in the silent mode than that in the normal mode.

FIG. 18 illustrates a flow of changing the time interval T between sheets. First, in step S351, the sheet feeding control portion 402 determines whether the stapling mode is a silent mode. If the silent mode is determined (YES in step S351), the sheet feeding control portion 402 proceeds to step S353 to set a time interval T between sheets to equal T2. If the silent mode is not determined in step S351 (NO in step S351), the sheet feeding control portion 402 proceeds to step S352 to set a time interval T between sheets to equal T1. In this case, T1<T2 is established. In other words, in the second print mode, such as a two-sized print mode or a large-size print mode, a longer interval T2 between sheets is set than an interval T1 between sheets in the first print mode, such as a one-sided print mode or a small-size print mode. As the interval T2 between sheets is set in the second print mode in this manner, the moving speed of the driver portion 821 can be set low as in the silent mode. As a result, an impact noise generated when the driver portion 821 contacts a sheet bundle can be reduced.

### Second Exemplary Embodiment

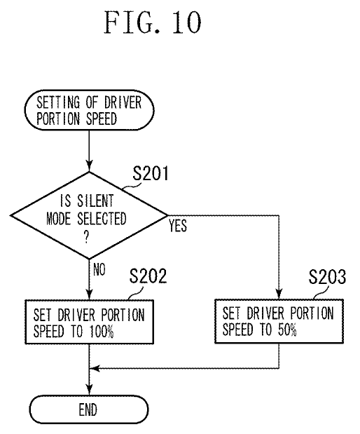

Next, referring to FIG. 10, a flow of determining a moving speed of the driver portion 821, which serves as a contact portion of the stapler 601, when the stapling mode is selected via the operation portion 153 according to a second exemplary embodiment will be described.

First, in step S201, the finisher control portion 501 determines whether a silent mode has been selected via the operation portion 153. Information on the mode set via the operation portion 153 is transmitted from the image forming apparatus to the finisher 500 via the communication IC 514. If the silent mode is not selected (NO in step S201), the finisher control portion 501 proceeds to step S202 to set the moving speed of the driver portion 821 to 100%. This speed is the highest moving speed of the driver portion 821. If the silent mode is determined to be selected in step S201 (YES in step S201), the finisher control portion 501 proceeds to step S203 to set the moving speed of the driver portion 821 to 50% of the highest moving speed. By setting low the moving speed of the driver portion 821 in the silent mode, an impact noise generated when the driver portion 821 contacts a sheet bundle can be reduced.

This processing enables a user to optionally select the silent mode according to an environment in which the apparatus is used.

In the foregoing, the silent mode is selected by an input via the operation portion 153. However, the silent mode can be selected based on a command from a printer driver installed on a computer (not shown) connected to the image forming apparatus via a network.

### Third Exemplary Embodiment

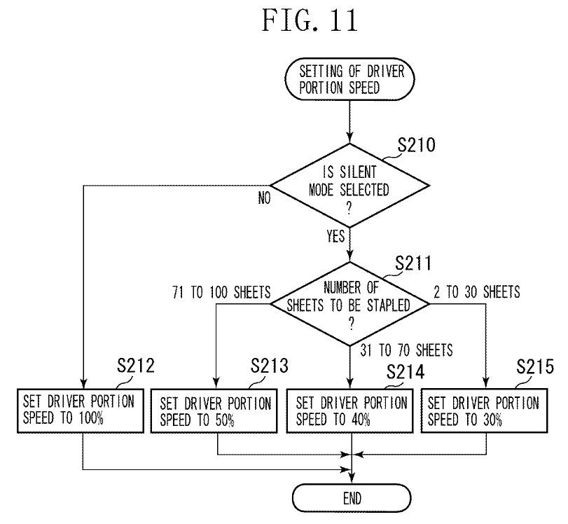

Next, referring to FIG. 11, a flow of changing the moving speed of the driver portion 821 of the stapler 601 based on the number of sheets to be stapled according to a third exemplary embodiment of the present invention will be described.

First, in step S210, the finisher control portion 501 determines whether a silent mode is selected. If the silent mode is determined to be selected in step S210 (YES in step S210), the finisher control portion 501 proceeds to step S211 to count the number of sheets to be stapled. The number of sheets can be counted by counting input signals from the entrance sensor 531, i.e., the number of sheets passing through the entrance sensors 531 with the post-processed sheet number counting portion 956. Then, if the number of sheets to be stapled is 2 to 30, the finisher control portion 501 sets the moving speed of the driver portion 821 to 30% of the normal moving speed (step S215). If the number of sheets to be stapled is 31 to 70, the finisher control portion 501 sets the moving speed of the driver portion 821 to 40% of the normal moving speed (step S214). If the number of sheets to be stapled is 71 to 100, the finisher control portion 501 sets the moving speed of the driver portion 821 to 50% of the normal moving speed (step S213). If the silent mode is determined not to be selected in step S210 (NO in step S210), the finisher control portion 501 sets the moving speed of the driver portion 821 to 100% (step S212).

Generally, an impact noise generated at the driver portion 821 is lager as the number of sheets to be stapled is smaller. The impact noise is absorbed in a sheet bundle to be reduced as the number of sheets to be stapled is larger. Setting the moving speed of the driver portion 821 lower than necessary adversely affects printing productivity. Thus, it is useful to appropriately set the moving speed of the driver portion 821 according to the number of sheets to be stapled.

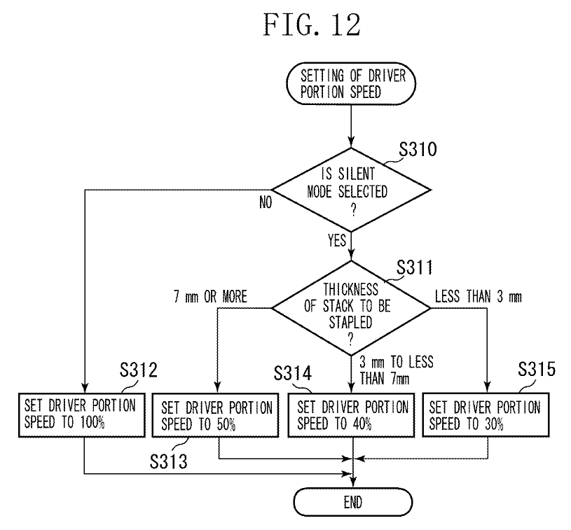

In FIG. 11, the moving speed of the driver portion 821 is determined based on the number of sheets to be stapled. However, sheets to be stapled may vary in their thickness, and a thick sheet may be fed from an inserter. In such a case, the moving speed of the driver portion 821, which serves as a contact portion, can be changed based on the thickness of a sheet bundle calculated by the bundle thickness determination portion 957 in place of the number of sheets to be stapled. Referring to the flowchart of FIG. 12, a processing flow in this case will be described.

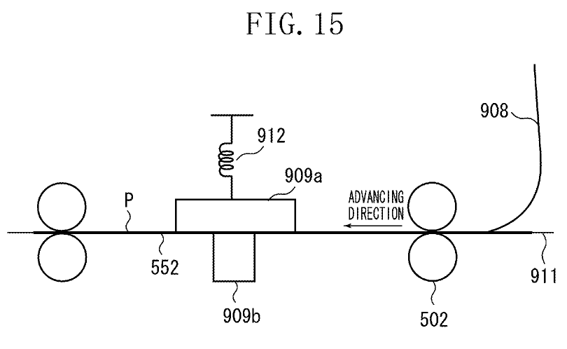

First, in step S310, the finisher control portion 501 determines whether the silent mode is selected. If the silent mode is determined to be selected in step S310 (YES in step S310), the finisher control portion 501 proceeds to step S311 to calculate the thickness of a sheet bundle to be stapled. In this case, the thickness can be detected using the sheet thickness detection sensor 909, such as the one illustrated in FIG. 15 (described below). If the thickness of the bundle is less than 3 mm, the finisher control portion 501 sets the moving speed of the driver portion 821 to 30% of the normal moving speed (step S315). If the thickness of the bundle is equal to or more than 3 mm to less than 7 mm, the finisher control portion 501 sets the moving speed of the driver portion 821 to 40% of the normal moving speed (step S314). If the thickness of the bundle is equal to or more than 7 mm, the finisher control portion 501 sets the moving speed of the driver portion 821 to 50% of the normal moving speed (step S313). If the silent mode is determined not to be selected in step S310 (NO in step S310), the finisher control portion 501 sets the moving speed of the driver portion to 100% of the normal moving speed (step S312).

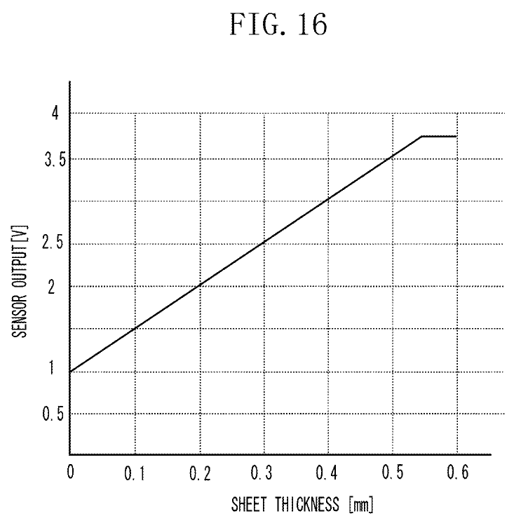

Referring to FIG. 15, the sheet thickness detection sensor 909 will be described. The sheet thickness detection sensor 909 includes a movable core 909a made of a magnetic material and a magnetic field sensor 909b including a Hall element. The movable core 909a is pressed against the magnetic field sensor 909b by a given force of a spring 912. A sheet P is guided between the movable core 909a and the magnetic field sensor 909b. The position of the movable core 909a is shifted according to the thickness of the sheet P, thus causing a change in size of a magnetic field generated by the movable core 909a and detected by the magnetic field sensor 909b. At this time, a signal output from the magnetic field sensor 909b corresponds to the thickness of the sheet P. FIG. 16 illustrates an output of the magnetic field sensor 909b corresponding to the sheet thickness. The output of the magnetic field sensor 909b is input to an A/D input portion (not shown) of the CPU circuit portion 950 to obtain sheet thickness data. For example, the sheet thickness is 0.1 mm when the sensor output is 1.5 V.

The thickness of a sheet bundle can be calculated by integrating thicknesses of a number of sheets to be stapled.

As described above, according to an exemplary embodiment of the present invention, when a print mode is set, for example, to a two-sided printing mode or a large-size printing mode, the moving speed of a contact portion of a stapler is set lower than that in a one-sided printing mode or a small-size printing mode. Thus, an impact noise generated when the driver portion contacts a sheet bundle can be reduced. As a result, an operation noise generated during a stapling operation can be reduced without lowering productivity.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2006-166199 filed Jun. 15, 2006, No. 2006-341404 filed Dec. 19, 2006, and No. 2007-110537 filed Apr. 19, 2007, which are hereby incorporated by reference herein in their entirety.

What is claimed is:

1. A sheet processing apparatus coupled to an image forming apparatus having a first print mode and a second print mode in which an interval between sheets is larger than that in the first print mode when images are formed on sheets, the sheet processing apparatus comprising:
a stapling unit configured to perform a stapling process on a bundle of image-formed sheets; and
a controller configured to control the stapling unit such that a moving speed at which the stapling unit presses the sheet bundle for the stapling process in the second print mode is lower than that in the first print mode.

2. The sheet processing apparatus according to claim 1, wherein the first print mode includes a one-sided print mode and the second print mode includes a two-sided print mode.

3. The sheet processing apparatus according to claim 1, wherein the first print mode includes a small-size print mode and the second print mode includes a large-size print mode.

4. The sheet processing apparatus according to claim 1, further comprising a switching portion operable to select a mode to reduce noise during the stapling process.

5. The sheet processing apparatus according to claim 1, further comprising a counting portion configured to count a number of sheets to be stapled,
wherein the controller changes the moving speed according to the number of sheets counted by the counting portion.

6. The sheet processing apparatus according to claim 1, further comprising a thickness calculation portion configured to determine a thickness of a sheet bundle to be stapled,
wherein the controller changes the moving speed according to the thickness of the sheet bundle calculated by the thickness calculation portion.

7. An image forming apparatus comprising:
an image forming portion configured to form an image on a sheet; and
the sheet processing apparatus according to claim 1.

8. An image forming apparatus having a first print mode and a second print mode in which an interval between sheets is larger than that in the first print mode when images are formed on sheets, the image forming apparatus comprising:
an image forming portion configured to form an image on a sheet;
a sheet processing apparatus configured to process a bundle of the image-formed sheets; and
a controller configured to control the sheet processing apparatus,
wherein the sheet processing apparatus includes a stapling unit configured to perform a stapling process on the sheet bundle, the stapling unit being controlled such that a moving speed at which a driver portion of the stapling unit moves toward the sheet bundle during a stapling process is set lower in the second print mode than in the first print mode.

9. The image forming apparatus according to claim 8, wherein the first print mode includes a one-sided print mode and the second print mode includes a two-sided print mode.

10. The image forming apparatus according to claim 8, wherein the first print mode includes a small-size print mode and the second print mode includes a large-size print mode.

11. The image forming apparatus according to claim 8, further comprising a switching portion operable to switch the moving speed.

12. The image forming apparatus according to claim 8, further comprising a counting portion configured to count a number of sheets to be stapled, wherein the controller changes the moving speed according to the number of sheets counted by the counting portion.

13. The image forming apparatus according to claim 8, further comprising a thickness calculation portion configured to determine a thickness of a sheet bundle to be stapled,
wherein the controller changes the moving speed according to the thickness of the sheet bundle calculated by the thickness calculation portion.

14. The image forming apparatus according to claim 8, further comprising:
a sheet feeding portion configured to feed a sheet to the image forming portion; and
a sheet feeding control portion configured to control timing at which the sheet feeding portion feeds a sheet,
wherein the sheet feeding control portion controls the sheet feeding portion based on an interval between sheets to be fed calculated according to the printing mode.

15. A method comprising:
forming images on sheets;
stacking the image-formed sheets to be stapled;
determining whether the image-formed sheets are printed in a first print mode or in a second print mode; and
controlling a moving speed at which a driver portion of a stapling unit moves towards the stacked sheets during a stapling operation based on whether the image-formed sheets are printed in the first print mode or in the second print mode.

16. The method according to claim 15, wherein a time interval of forming images on a sheet is longer in the second print mode than in the first print mode,
wherein the moving speed at which the driver portion of the stapling unit moves towards the stacked sheets during the stapling operation is set lower in the second print mode than in the first print mode.

17. The method according to claim 16, wherein the first print mode includes a one-sided print mode and the second print mode includes a two-sided print mode.

18. The method according to claim 16, wherein the first print mode includes a small-size print mode and the second print mode includes a large-size print mode.

19. The method according to claim 15, further comprising:
counting a number of sheets to be stapled, wherein the moving speed at which the driver portion of the stapling unit moves towards the stacked sheets is controlled based on the counted number of sheets to be stapled.

20. The method according to claim 15, further comprising:
determining a thickness of the stacked sheets to be stapled, wherein the moving speed at which the driver portion of the stapling unit moves towards the stacked sheets is controlled based on the determined thickness of the stacked sheets to be stapled.
